(19) United States
(12) Patent Application Publication
(10) Pub. No.: US 2013/0044916 A1
(43) Pub. Date: Feb. 21, 2013

(54) METHOD AND APPARATUS OF PUSH & PULL GESTURE RECOGNITION IN 3D SYSTEM

(71) Applicants: Peng Qin, Beijing (CN); Lin Du, Beijing (CN); Sinan Shangguan, Beijing (CN)

(72) Inventors: Peng Qin, Beijing (CN); Lin Du, Beijing (CN); Sinan Shangguan, Beijing (CN)

(73) Assignee: THOMSON LICENSING, Issy de Moulineaux (FR)

(21) Appl. No.: 13/695,057

(22) PCT Filed: Apr. 30, 2010
(86) PCT No.: PCT/CN10/00602

§ 371 Date: Oct. 29, 2012

(51) Int. Cl. G06K 9/78

(52) U.S. Cl. 382/103

(57) ABSTRACT

The present invention provides method and apparatus of PUSH & PULL gesture recognition in 3D system. The method comprising determining whether the gesture is PUSH or PULL as a function of distances from the object performing the gesture to the cameras and the characteristics of moving traces of the object in the image planes of the two cameras.

### FIELD OF THE INVENTION

The present invention relates generally to three dimensional (3D) technology, and more particularly, to method and apparatus of PUSH & PULL gesture recognition in 3D system.

### BACKGROUND OF THE INVENTION

With the advent of more and more 3D movies, 3D rendering devices for home users are becoming more and more common. Followed by the arrival of a 3D user interface (UI), it is clear that the use of gesture recognition is the most direct way for 3D UI controls. PULL and PUSH are two popular gestures among those to be recognized. It can be appreciated that a PULL gesture can be understood as user takes object closer to him/her, and a PUSH gesture can be understood as user push the object away.

Conventional PULL and PUSH recognition is based on the distance variation between the hand of a user and a camera. Specifically, if the camera detects that the above distance is reduced, then the gesture will be determined as PUSH; while if the distance is increased, then the gesture will be determined as PULL.

FIG. 1 is an exemplary diagram showing a dual camera gesture recognition system in the prior art.

As shown in FIG. 1, two cameras are used for the gesture recognition. The camera can be a webcam, a WiiMote IR camera or any other type of camera that can detect the finger trace of a user. For example, IR cameras can be used to trace an IR emitter in the user's hand. Please note, although the finger trace detection is also an important technology in gesture recognition, it is not the subject matter that would be discussed by the present invention. Therefore, in this disclosure we assume that the user's finger trace can be easily detected by each camera. Additionally, we assume the camera is in the top left coordinates system throughout the ,whole disclosure.

FIG. 2 is an exemplary diagram showing the geometry of depth information detection by the dual camera gesture recognition system of FIG. 1. Please note the term depth here refers to the distance between the object of which the gesture is to be recognized and the imaging plane of a camera.

The left camera L and the right camera R which have the same optical parameter are respectively allocated at oₗ and oᵣ, with their lens axis being vertical to the connection line between oₗ and oᵣ. Point P is the object to be reconstructed, which is the user's finger in this case. Point P needs to be located within the lens of two cameras for the recognition.

Parameter f in FIG. 2 is the focal length of the two cameras. pₗ and pᵣ in the FIG. 2 represent virtual projection planes of the left and right cameras respectively. T is the distance between two cameras. Z is the vertical distance between the point P and the connection line of the two cameras. During the operation of the system, P will be imaged respectively on virtual projection planes of the two cameras. Since two camera are arrangement frontal parallel (the images are row-aligned and that every pixel row of one camera aligns exactly with the corresponding row in the other camera), xᵣand xₗ are the x-axis coordinates of the point P in left and right camera. According to the trigonometric theory, the relationship of these parameters in FIG. 2 can be described by the following equation:

$$\frac{T}{Z} = \frac{T - ( {x}_{l} - {x}_{r} )}{Z - f} ; Z = \frac{T \cdot f}{{x}_{l} - {x}_{r}} = \frac{T \cdot f}{d}$$

At above formula, d is the disparity which is defined simply as by d=xₗ−xᵣ.

However, in 3D user interface, there are many other gestures to be recognized, such as RIGNT, LEFT, UP, DOWN, VICTORY, CIRCLE, PUSH, PULL and PRESS, which may also result in the depth variation in the camera. Therefore, in the conventional art where PULL and PUSH are determined solely based on the depth information, there might be a false recognition.

### SUMMARY OF THE INVENTION

According to one aspect of the invention, there is provided a method of gesture recognition by two cameras, comprising determining whether the gesture is PUSH or PULL as a function of distances from the object performing the gesture to the cameras and the characteristics of moving traces of the object in the image planes of the two cameras.

According to another aspect of the invention, there is provided an apparatus of gesture recognition by two cameras, comprising means for determining whether the gesture is PUSH or PULL as a function of distances from the object performing the gesture to the cameras and the characteristics of moving traces of the object in the image planes of the two cameras.

### BRIEF DESCRIPTION OF DRAWINGS

These and other aspects, features and advantages of the present invention will become apparent from the following description in connection with the accompanying drawings in which:

FIG. 1 is an exemplary diagram showing a dual camera gesture recognition system in the prior art;

FIG. 2 is an exemplary diagram showing the geometry of depth information detection by the dual camera gesture recognition system of FIG. 1;

FIG. 3 is an exemplary diagram showing the finger trace in the left and right cameras for the PUSH gesture;

FIG. 4 is an exemplary diagram showing the finger traces in the left and right cameras for the PULL gesture;

FIG. 5-8 are exemplary diagrams respectively showing the finger traces in the left and right cameras for the gestures of LEFT, RIGHT, UP and DOWN;

FIG. 9 is a flow chart showing a method of gesture recognition according to an embodiment of the invention;

FIG. 10 is an exemplary diagram showing the stereo view range in different arrangement of stereo cameras;

FIG. 11 is an exemplary diagram showing the critical line estimation method for stereo camera placed with a angle;

FIG. 12 is a flow chart of a method for determination of the logical left and right cameras.

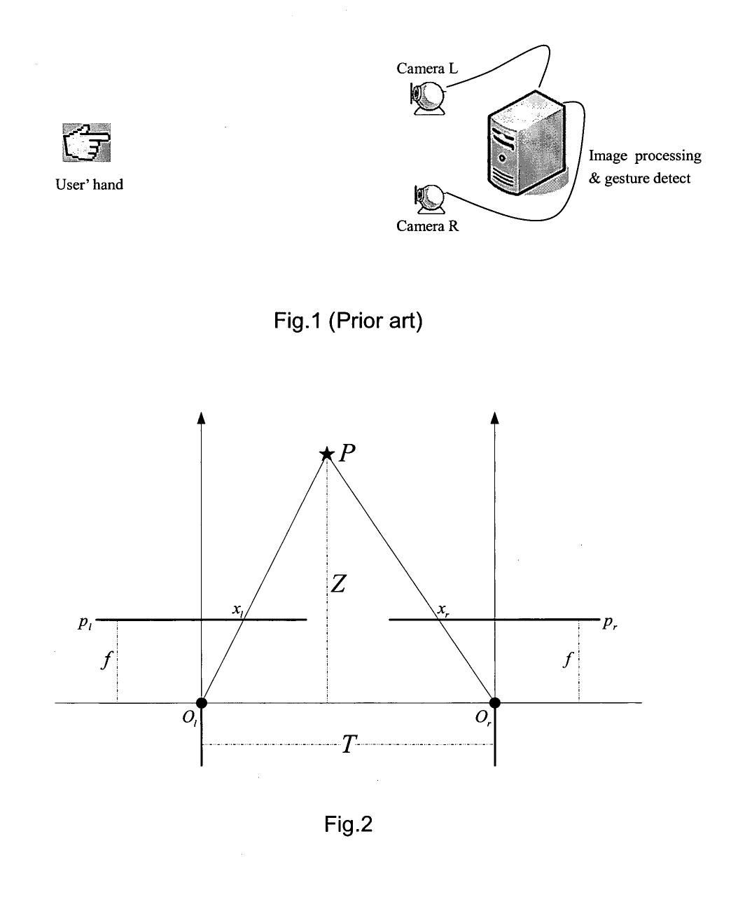

### DETAIL DESCRIPTION OF PREFERRED EMBODIMENTS

In the following description, various aspects of an embodiment of the present invention will be described. For purposes of explanation, specific configurations and details are set forth in order to provide a thorough understanding. However, it will also be apparent to one skilled in the art that the present invention may be practiced without the specific details present herein.

In view of the foregoing disadvantages of the prior art, an embodiment of the present invention provides method and apparatus of PUSH & PULL gesture recognition in 3D system, which recognizes the PUSH & PULL gesture as a function of the depth variation and movement trace imaged in a plane vertical to the depth direction of the two cameras.

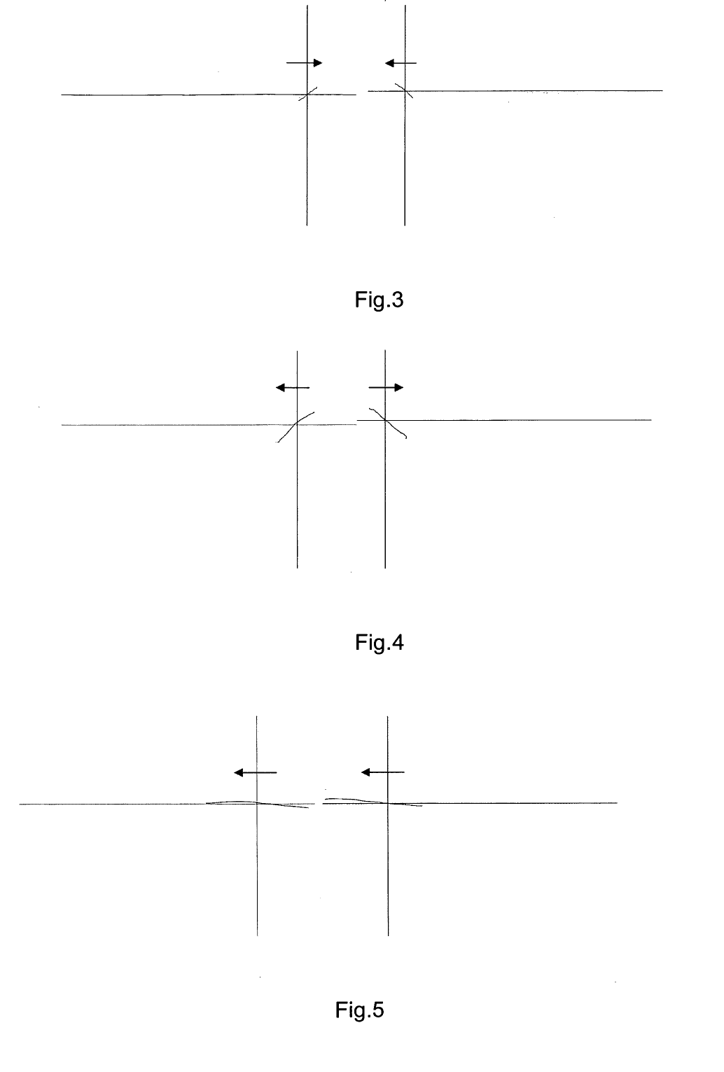

Firstly, the study of the inventor on the finger trace in the left and right cameras for a plurality of gestures will be described with reference to FIGS. 3-8.

In FIGS. 3-8, the horizontal and vertical lines are the coordinate axes as a base of the middle point of one gesture, and the arrow line indicates the direction of movement in the corresponding cameras. In the FIGS. 3-8, the coordinate origin is in the upper left corner. The X-axis coordinate increases as right direction and the Y-axis coordinates increase downwards. Z-axis coordinates was not shown in FIGS. 3-8, which is vertical to the plane defined by the X-axis and Y-axis.

FIG. 3 is an exemplary diagram showing the finger trace in the left and right cameras for the PUSH gesture. As shown in FIG. 3, for a PUSH gesture, besides the depth variation (a reduction), the finger traces in the left and right cameras move towards each other.

FIG. 4 is an exemplary diagram showing the finger traces in the left and right cameras for the PULL gesture. As shown in FIG. 4, for a PULL gesture, besides the depth variation (an increase), the finger traces in the left and right cameras move away from each other.

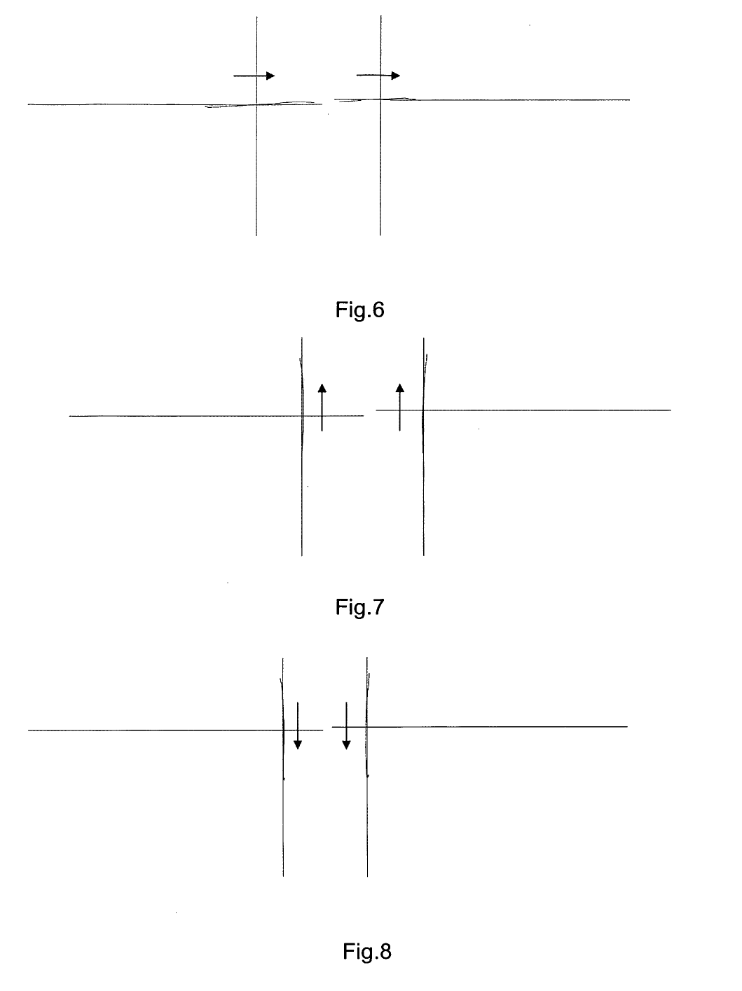

FIG. 5-8 are exemplary diagrams respectively showing the finger traces in the left and right cameras for the gestures of LEFT, RIGHT, UP and DOWN. As shown in these figures, for the LEFT, RIGHT, UP and DOWN gestures, the finger traces in the left and right cameras move to the same direction, although they may also introduce depth variations.

Thus it can be seen, in addition to the depth variation, the movement directions of the finger trace in the X-axis for the PUSH and PULL gestures in the left and right cameras are quite different from those of the UP, DOWN, RIGHT, LEFT gestures.

In addition, the movement ratio of the finger trace in the X-axis and Y-axis in the left and right cameras is also different between the PUSH, PULL gestures and the other gestures mentioned above.

Since LEFT, RIGHT, UP and DOWN gestures may also introduce variations in the Z axis, if the recognition of the PUSH and PULL gestures is only based on the depth variation, that is ΔZ (the end-point's z minus the begin-point's z) in this case, the LEFT, RIGHT, UP and DOWN gestures may also be recognized as PUSH or PULL.

In view of the above, the embodiment of the invention proposes to recognize the PUSH & PULL gesture based on the ΔZ and the movement directions of finger trace in the X axis in the left and right cameras.

In addition, the scale in the X and Y axis can also be considered for the gesture recognition.

The following table shows the gesture recognition criteria based on the above parameters.

| | Movement | Movement | | |
|---|---|---|---|---|
| | direction | direction | | |
| | in | in X axis | | |
| | X axis in | trend | | |
| | Left | in right | | |
| Gesture | camera | camera | Scale (X/Y) | ΔZ |
| PUSH | → | ← | >TH_XY_MIN | >TH_Z |
| PULL | ← | → | >TH_XY_MIN | >TH_Z |
| LEFT | ← | ← | >=TH_XY_MAX \|\| | Don't |
| | | | (TH_XY_MIN, | care |
| | | | TH_XY_MAX) | |
| | | | &&abs(ΔX) > abs(ΔY) | |
| | | | && ΔX < 0 | |
| RIGHT | → | → | >=TH_XY_MAX \|\| | Don't |
| | | | (TH_XY_MIN, | care |
| | | | TH_XY_MAX) | |
| | | | &&abs(ΔX) > abs(ΔY) | |
| | | | && ΔX > 0 | |
| UP | Don't care | Don't care | <=TH_XY_MIN \|\| | Don't |
| | | | (TH_XY_MIN, | care |
| | | | TH_XY_MAX) | |
| | | | &&abs(ΔY) >= abs(ΔX) | |
| | | | && ΔY < 0 | |
| DOWN | Don't care | Don't care | <=TH_XY_MIN \|\| | Don't |
| | | | (TH_XY_MIN, | care |
| | | | TH_XY_MAX) | |
| | | | &&abs(ΔY) >= abs(ΔX) | |
| | | | && ΔY > 0 | |

In the above table, scale

$$( \frac{x}{y} ) = \frac{max ( x ) - min ( x )}{max ( y ) - min ( y )} .$$

TH_Z is a threshold set for the ΔZ.

In the above table, the arrow line means the movement direction of X-axis for every gesture. It can be seen that x-axis movement direction and scale(x/y) can be used to distinguish PUSH/PULL from LEFT/RIGHT, because for LEFT/RIGHT gesture the x-axis movement have the same direction in two cameras and scale(x/y) will be very large for LEFT/RIGHT gesture. Scale(x/y) can be used to distinguish PUSH/PULL from UP/DOWM, because scale(x/y) will be very small for UP/DOWN gesture.

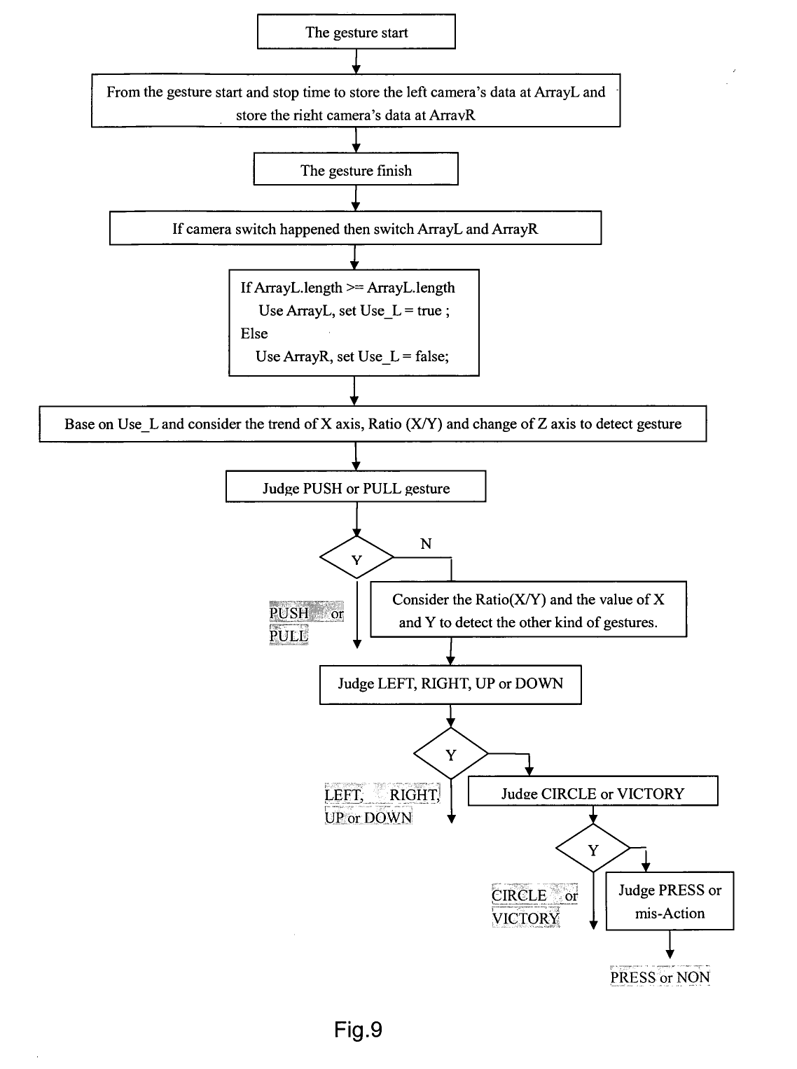

FIG. 9 is a flow chart showing a method of gesture recognition according to an embodiment of the invention.

As shown in FIG. 9, from the gesture start time to the gesture stop time, data captured by the left and right cameras will be stored respectively at ArrayL and ArrayR.

It should be noted that the notion of left and right camera is from the logical point of view. That is, they are both logic cameras. For example, the left camera is not the camera which is set at the left position of the screen). Therefore, in the following step, the recognition system detects a camera switch, the ArrayL and ArrayR will be switched.

Then in the following steps, gestures will be recognized based on the depth variation, the movement directions of the finger trace in the X-axis for in the left and right cameras, and the Scale (X/Y), as described in the above-described table.

As shown by FIG. 9, the PULL and PUSH gestures have the higher priority. The LEFT, RIGHT, UP and DOWN have the second priority. The CIRCLE and VICTORY have the third priority, and PRESS and non-action have the lowest priority. The advantage for such priority ranking is to improve the PULL and PUSH gesture recognition rate, and can filter some user's misuse.

If set stereo cameras were set as frontal parallel, then depth view range may be small in some usage scenarios. Therefore, in some cases the stereo cameras will be placed with certain angles.

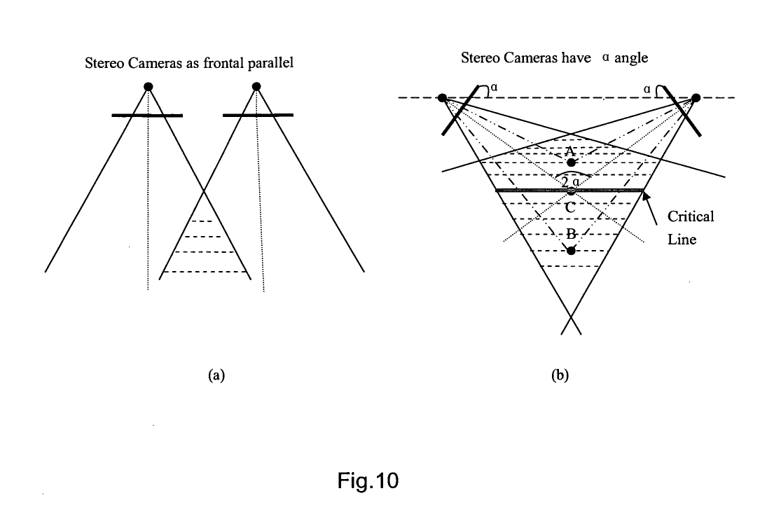

FIG. 10 is an exemplary diagram showing the stereo view range in different arrangement of stereo cameras. FIG. 10(a) shows the stereo cameras was set as frontal parallel. FIG. 10(b) shows that the stereo cameras have α angle.

The actual image plane is the lens convergence surface, so the actual image plane should behind the lens. Under the premise of guaranteeing the correctness, for ease of understanding we will draw the image plane in front of the camera and make lens into one point.

If the stereo cameras have a angle in placement as shown by FIG. 10(b), then there will be one critical line which is through the two camera optical axis crossing point (dot C) and parallel with the horizontal line. In fact, users can have a rough estimation of the location of point C: the cross point main optical axis of the two cameras, and at this time the angle between the two main optical axis is 2α. If a light dot is above this critical line (for example, dot A), then X-axis value in left camera will be greater than right camera. If a light dot is below this critical line (for example, dot B), then X-axis value in left camera will be smaller than right camera. That is to say, if one light dot moves far away from the stereo camera, then the disparity value (x-axis coordinates of the left camera, minus the value of the right camera x-axis coordinate values) will have a trend that decreases from positive to zero then go to negative values.

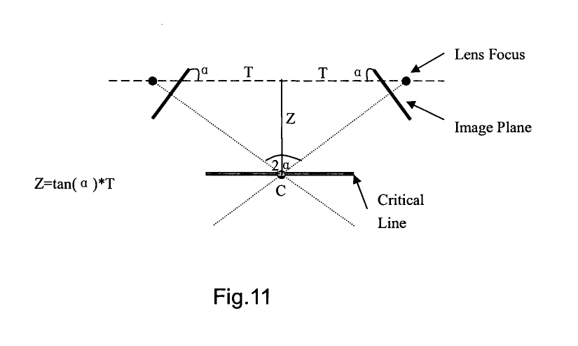

FIG. 11 is an exemplary diagram showing the critical line estimation method for stereo camera placed with α angle.

If the image plane (or camera) relative to the horizontal deflection angle of α, according to the triangle on the above figure, we can see that the distance Z between critical line and the camera as this formula:

Z=tan(α)*T

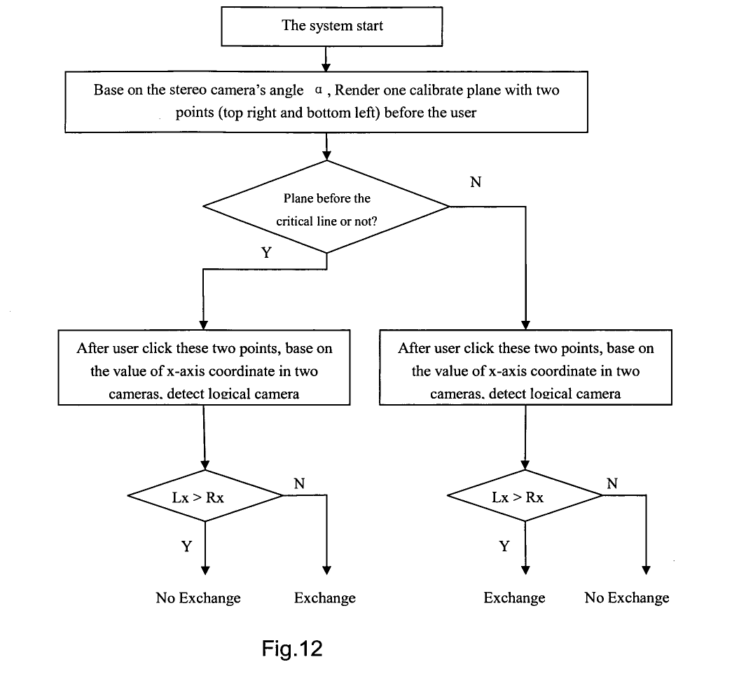

After the critical line of stereo camera placed with α angle is estimated, the logical left or right camera can be detected. FIG. 12 is a flow chart of a method for determination of the logical left and right cameras.

As shown in FIG. 12, when the recognition system is started, a calibrate plane with two points (top right and bottom left) will be rendered before the user based on the angle of the two stereo cameras.

Next, the system will determine whether the plane is before the critical line or not.

If the plane is before the critical line, the logical camera will be detected based on the value of X-axis coordinate in the two cameras after the user clicks the two points. In particular, if the Lx>Rx, then it is not necessary to exchange the two logical cameras. Otherwise, the two logical cameras need to be exchanged.

If the plane is not before the critical line, the logical camera will be detected based on the value of X-axis coordinate in the two cameras after the user clicks the two points. In particular, if the Lx>Rx, then it is necessary to exchange the two logical cameras. Otherwise, the two logical cameras need not to be exchanged.

It can be appreciated by a person skilled in the art that if the stereo cameras have frontal parallel placement, the calibrate plane will be at infinite place. Therefore, we only need compare Lx and Rx to judge the camera exchange or not. Because in frontal parallel placement, Lx and Rx for logical left and right camera will have the fixed relationship, for example Lx>Rx. If we detect Lx>Rx, then camera do not exchange, if we detect Lx<Rx, then camera have been exchanged, that is to say logical left camera at the right position and logical right camera at the left position.

It is to be understood that numerous modifications may be made to the illustrative embodiments and that other arrangements may be devised without departing from the spirit and scope of the present invention as defined by the appended claims.

1. A method of gesture recognition by two cameras, comprising
determining whether an object is close to or away from a connection line of two cameras as a function of the depth variations of images of the object captured by the two cameras and the characteristics of moving traces of the images of the object in the image planes of the two cameras.

2. The method according to claim 1, wherein the characteristic of a moving trace of the image. of the object in an image plane of a camera comprise a movement direction in of one of two axes defining the image plane of the camera.

3. The method according to claim 2, wherein the object is determined to be close to the connection line of two cameras by a decreasing of the depth variations both being larger than a predetermined threshold the movement direction of the moving trace of the object in an axis of one camera being different from that in the axis of another camera with the two cameras defined by the same coordinates system.

4. The method according to claim 3, wherein the moving traces in the two cameras move toward each other in said axis.

5. The method according to claim 2, wherein a the object is determined to be away from the connection line of two cameras by an increasing of the depth variations both being larger than a predetermined threshold and the movement direction of the moving trace of the object in an axis one camera being different from that in the same axis of another camera with the two cameras defined by the same coordinates system.

6. The method according to claim 5, wherein the moving traces in the two cameras move away from each other in said axis.

7. The method according to claim 1, wherein the characteristic of a moving trace of the object in an image plane of a camera comprise a ratio between the coordinates of the moving trace in the two axes of the image plane of the camera.

8. An apparatus, comprising
means for determining whether an object is close to or away from a connection line of two cameras as a function of the depth variations of images of the object captured by the two cameras and the characteristics of moving traces of the images of the object in the image planes of the two cameras.
